(19) United States
(12) Patent Application Publication
(10) Pub. No.: US 2019/0133028 A1
(43) Pub. Date: May 9, 2019

(54) RADIUS NOSE CARBIDE FOR FURROWING TIP

(71) Applicant: DUTCH BLACKSMITH SHOP LTD., Pilot Butte (CA)

(72) Inventor: Rogan David Milatz, Regina (CA)

(21) Appl. No.: 15/804,567

(22) Filed: Nov. 6, 2017

(51) Int. Cl. A01C 5/06

(52) U.S. Cl. CPC A01C 5/062; B23K 2201/00

(57) ABSTRACT

A furrow opener for an agricultural implement includes a main body defining a knife and a wing body defining a pair of wings. The wings include respective leading edge members of wear resistant material along a front thereof which extend forwardly at a laterally inward slope towards a common junction on the wing body. A front end face on the wing body at the common junction is oriented perpendicularly to a forward direction of the opener. A nose member of wear resistant material spans across the front end face of the wing body and the front ends of the leading edge members of the wings to define a radius of curvature between the leading edges of the wings.

### FIELD OF THE INVENTION

The present invention relates to a furrow opener including an upright knife portion and a wing portion at a bottom end of the knife portion, and more particularly, the present invention relates to a furrow opener including a nose carbide supported at a forward apex of the wing portion.

### BACKGROUND

Agricultural seeding implements commonly include a plurality of tool shanks which mount respective furrow openers thereon for forming respective furrows in the ground as the implement is towed in a forward working direction. A pneumatic seed delivery system typically delivers seed into the furrow through a pneumatic seed delivery passage extending through the furrow opener. In some instances, the furrow opener is equipped with a wing portion cable of forming a furrow with sufficient width to deposit two spaced apart rows of seed. The forward end of the wing body is typically formed as an apex for penetrating the soil as the implement is advanced across the ground; however, the apex is subject to considerable wear and possible breakage. In some instances, a vertical knife portion is formed ahead of the apex of the wing portion such that the wings trail the leading edge of the wing portion to avoid use of a protruding apex on the wing portion; however, the furrow opener may have a higher soil penetration resistance in this instance.

### SUMMARY OF THE INVENTION

According to one aspect of the present invention there is provided a furrow opener for mounting on a tool shank of an agricultural seeding implement to form a furrow in ground as the implement is displaced across the ground in a forward working direction, the furrow opener comprising:

a main body;

a mounting arrangement at a rear side of the main body to mount on the tool shank of the implement;

an upright knife extending along a front side of the main body; and

a pair of wings protruding laterally outwardly from opposing sides of the main body, the wings including respective leading edges along a front thereof which extend forwardly at a laterally inward slope towards a common apex;

the common apex between the leading edges of the wings being spaced forwardly from a bottom end of the upright knife; and

the common apex forming a radius of curvature between the leading edges of the wings.

The arrangement of the wings which meet at an apex which is spaced forwardly of the knife edge together with a curved radius at the apex between the leading edges of the two wings, provides a wing arrangement that is resistant to wear and breakage, while maintaining a low soil penetration resistance for the overall opener.

Preferably, the radius of curvature is at least ¼ of an inch, and more preferably is closer to ½ an inch.

The wings preferably further comprise a wing body and a nose member supported on a front end of the wing body which defines the common apex in which the nose member is formed of a wear resistant material which is harder than a material of the opener body and a material of the wing body.

The wing body preferably includes a front end face which spans laterally between the leading edges of the wings so as to be oriented perpendicularly to the forward working direction in which the nose member has a rear end face opposite the common apex which is in abutment against the front end face of the wing body.

The wings preferably further include a pair of leading edge members supported on the wing body which define the leading edges of the wings in which the leading edge members are formed of a wear resistant material which is harder than a material of the opener body and a material of the wing body.

The nose member preferably extends laterally outwardly in opposing directions in overlapping configuration across front ends of the pair of leading edge members respectively.

When the wing body includes a front end face which spans laterally between the leading edges of the wings so as to be oriented perpendicularly to the forward working direction, the front ends of the pair of leading edge members preferably lie in a common plane with the front end face of the wing body.

The nose member may further include a front edge defining the radius of curvature of the common apex and an upper surface which is sloped upwardly and rearwardly from the front edge.

When the opener further comprises a leading edge member extending along a leading edge of the knife, the nose member is preferably supported on the wing body at a location which is spaced downwardly and forwardly from a bottom end of the leading edge member on the knife.

According to a second aspect of the present invention there is provided a method of forming a furrow opener for mounting on a tool shank of an agricultural seeding implement to form a furrow in ground as the implement is displaced across the ground in a forward working direction, the method comprising:

providing a main body having (i) a mounting arrangement at a rear side of the main body to mount on the tool shank of the implement, (ii) an upright knife extending along a front side of the main body, (iii) a wing body including a pair of wings protruding laterally outwardly from opposing sides of the main body, in which the wings include respective leading edges along a front thereof which extend forwardly at a laterally inward slope towards a common junction on the wing body, and in which the common junction between the leading edges of the wings is spaced forwardly from a bottom end of the upright knife; and

mounting a nose member on the common junction between the leading edges of the wings such that the nose member is spaced forwardly from a bottom end of the upright knife, in which the nose member forms a radius of curvature between the leading edges of the wings.

### BRIEF DESCRIPTION OF THE DRAWINGS

One embodiment of the invention will now be described in conjunction with the accompanying drawings in which:

FIG. 1 is a perspective view of a furrow opener showing a front, a top and a right side of the opener;

FIG. 2 is a side elevational view of the furrow opener;

FIG. 3 is a perspective view of the furrow opener showing a rear, a bottom and the right side of the opener;

FIG. 4 is a top view of the furrow opener; and

FIG. 5 is a bottom view of the furrow opener.

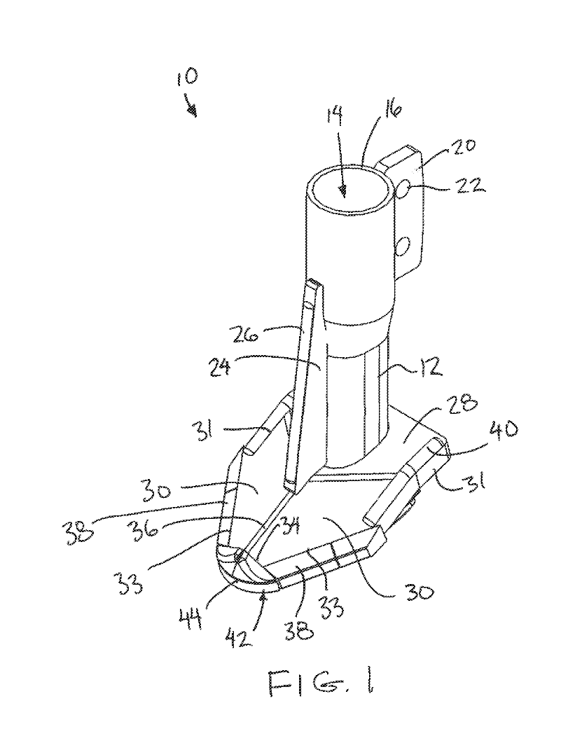

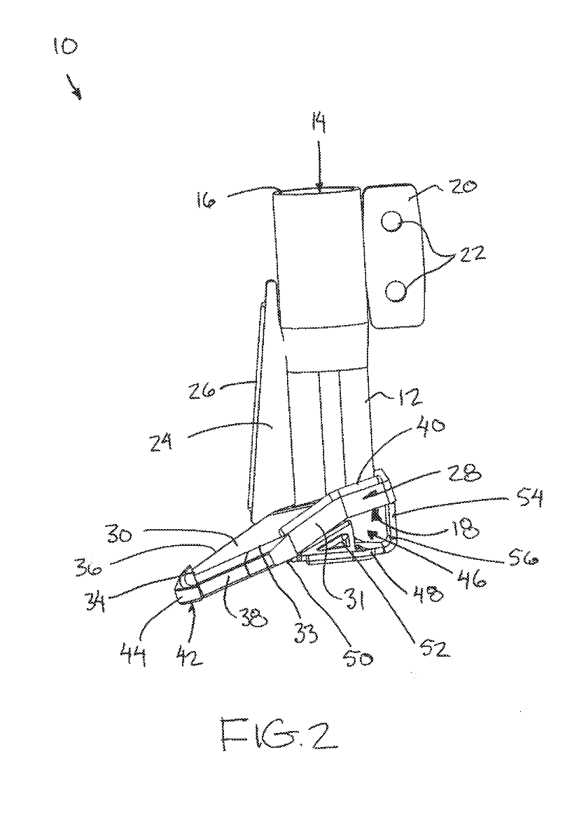

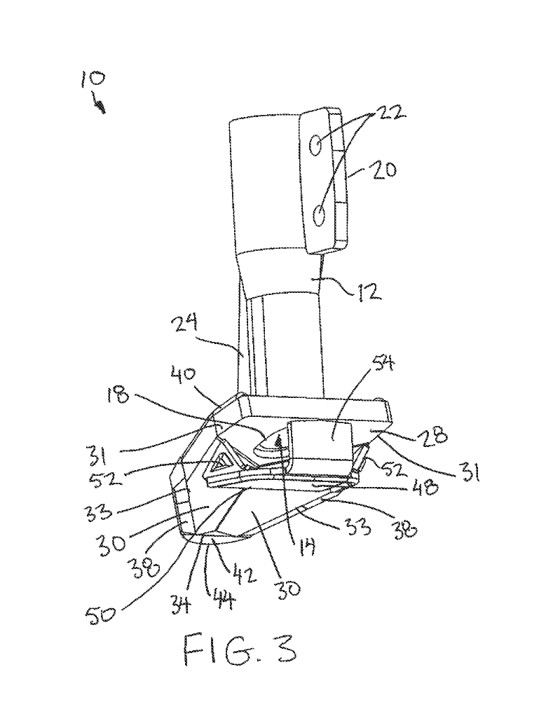

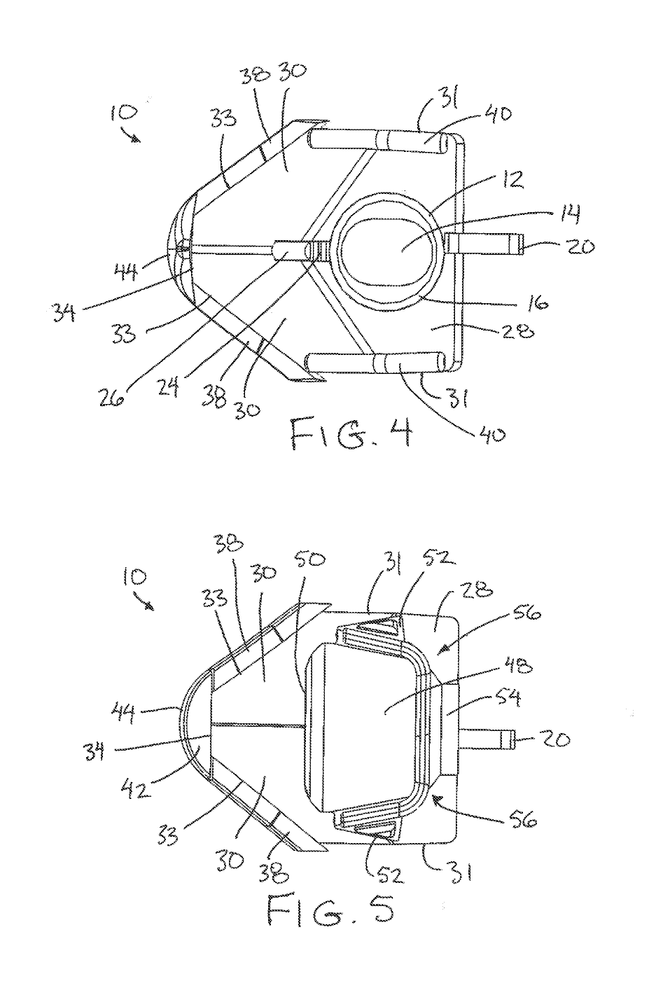

In the drawings like characters of reference indicate corresponding parts in the different figures.

### DETAILED DESCRIPTION

Referring to the accompanying figures, there is illustrated a furrow opener generally indicated by reference numeral 10.

The opener 10 is suited for use with an agricultural seeding implement of the type having a hitch for connection to a tractor which tows the implement in a forward working direction across the field. A plurality of tool shanks on the implement support respective openers 10 thereon such that each opener forms a furrow in the ground as the implement is towed in a forward working direction.

The implement typically further includes a seed delivery system including a seed tank for storing seed therein, and a metering device for metering seed from the seed tank into a plurality of pneumatic distribution lines. A blower provides an air flow in the distribution lines for carrying the seed from the metering device to respective ones of the openers 10.

Each opener includes a main body 12 in the form of a rigid tube defining a hollow delivery passage 14 therein which communicates from an open top end 16 to a bottom opening 18 of the tube. The open top end is adapted for mating communication with the end of a respective one of the pneumatic distribution lines of the implement.

A mounting arrangement is provided externally of the main body 12 at the rear side thereof adjacent the open top end 16. The mounting arrangement comprises a vertical flange 20 extending rearwardly from the top end of the rigid tube of the main body in a vertical plane lying parallel to the forward working direction. A plurality of mounting apertures 22 are formed in the vertical flange for receiving fasteners to fasten the opener to a tool shank on the implement frame. The mounting arrangement as illustrated accommodates one particular tool shank configuration, however in further embodiments the mounting arrangement may be configured differently for forming a mating connection with other tool shank configurations.

A knife portion 24 is supported on the front side of the main body 12 in the form of a vertical plate projecting forwardly from the rigid tube of the main body 12, while being oriented within a vertical plane lying parallel to the forward working direction. The plate forming the knife portion is generally triangular in shape having one side of the triangle fixed in abutment along the front side of the rigid tube such that another side of the triangle forms the leading edge of the knife which is sloped downwardly and forwardly from a top end of the knife portion spaced below the top end of the main body 12 to a bottom end of the knife portion which is near in elevation to the bottom opening 18 at the bottom of the rigid tube forming the main body.

A leading edge member 26 formed of a weld bead or of carbide so as to be harder and more wear resistant than the material of the main body is mounted along the leading edge of the knife portion to define the front side of the knife portion.

A wing body 28 is supported at the bottom end of the main body to define a pair of wings 30 protruding laterally outwardly from opposing sides of the main body. The wing body is much wider in the lateral direction and the longer in the forward working direction than a vertical thickness of the wing body so as to be generally plate-like. An opening extending vertically through the wing body is aligned with the bottom opening 18 of the main body 12 so that the delivery passage 14 communicates downwardly through the wing body 28.

The wings 30 at laterally opposing sides of the main body extend laterally outwardly to respective side edges 31 in which the two side edges are parallel to one another and parallel to the forward working direction and define the overall width in the lateral direction of the opener therebetween. Each wing also includes a front edge 33 at the front end thereof which is angled relative to the working direction to extend forwardly from the respective side edge 31 at a laterally inward slope.

A front end face 34 of the wing body spans in a lateral direction between the front ends of the two front edges 33 of the two wings such that the front end face is oriented generally perpendicularly to the forward working direction at the front end of the wing body.

The wing body 28 also includes a central ridge 36 lying in a common vertical plane with the knife portion and a central axis of the delivery passage. The central ridge 36 is connected between the bottom end of the knife portion and a laterally central location on the front end face 34. A bottom side of the triangular shape of the knife portion is in abutment with the upper surface of the wing body in alignment with the central ridge.

The upper surface of the wing body 28 is sloped downwardly and laterally outwardly from both sides of the ridge 36 in forming each of the two wings 30 of the wing body. The upper surface of the wing body is also sloped downwardly and forwardly from a rear edge of the wing body located rearwardly of the main body 12 towards the front end of the wing body.

A leading edge member 38 is mounted along the front edge of both wings. Each leading-edge member 38 is formed of carbide so as to be harder and more wear resistant than the material of the opener body or of the wing body. Each leading edge member is an elongate strip of material in direct abutment with the front edge of the respective wing to span a full thickness of the front edge of the wing and to extend laterally along the full length of the front edge. At the front end of each leading edge member 38, a front end face lies in a common plane with the front end face 34 of the wing body. At the rear ends, each leading-edge member 38 protrudes laterally outwardly slightly beyond the respective side edge 31 of the wing.

Each leading-edge member 38 may be formed in two sections connected in series. The sections are all secured to the wing body by welding, however in the event of damage to only one section, one section may be removed and a replacement section welded in place.

An auxiliary bead 40 of wear resistant material is provided along each side edge 31 of the wings at the upper surface of the wing body.

A nose member 42 is mounted on the front end of the wing body to span laterally across the full width of the front end face 34 and across the front ends of the two leading-edge members 38 of the two wings respectively. The nose member is formed of carbide so as to be harder and more wear resistant than the material of the opener body and the wing body. A front edge 44 of the nose member forms a constant radius of curvature across the full width in the lateral direction to connect between the leading edges of the two wings as defined by the leading-edge members 38. The radius of curvature of the front edge defines a common apex of the wings at a common junction between the leading-edge members 38 of the two wings and the front end face 34 at the front end of the wing body. The radius of curvature may be half an inch. An opposing rear side of the nose member 42 is flat and is abutted directly against the front end face 34 and the front ends of the two leading-edge members 38.

An upper surface of the nose member includes a central ridge at a laterally centred location thereon which is aligned with the central ridge and the upper surface of the wing body. The upper surface of the nose member extends downwardly from the central ridge at the rear side of the nose member at a lateral slope in opposing lateral directions from the central ridge and at a forward slope in a forward direction towards the front edge 44. An upper rear edge of the nose member is positioned to be slightly higher in elevation than the corresponding front upper edge of the wing body.

The wing body defines the upper boundary of a seed chamber 46 at the bottom end of the opener in open communication with the bottom opening 18 of the seed passage thereabove. A deflector 48 is mounted below the wing body to span beneath the open bottom end of the delivery passage 14 for forming the lower boundary of the seed chamber 46. The deflector 48 generally comprises a plate joined at a front edge 50 thereof to the bottom side of the wing body at an intermediate location between the front and rear ends thereof. The plate extends rearwardly from the front edge in near-perpendicular relation to the longitudinal axis of the delivery passage 14 such that the rear end of the plate is spaced below the rear end of the wing body.

A pair of side members 52 are provided in the form of triangular plates joined between corresponding side edges of the deflector plate 48 and the bottom side of the wing body thereabove for at least partially enclosing laterally opposing sides of the seed chamber 46.

A splitter plate 54 extends upwardly from the rear edge of the deflector plate 48 along a central portion thereof spanning approximately the width of the tube of the main body in the lateral direction. The splitter plate 54 is connected between the deflector plate and the bottom side of the wing body at the rear end thereof for only partially enclosing the rear side of the seed chamber 46.

The relationship of the splitter plate 54 to the side members 52 effectively defines two outlet openings 56 at laterally opposing sides of the delivery passage 14. Each outlet opening 56 is at least partially open at the rear side of the seed chamber and is at least partially open laterally outwardly from the seed chamber. In this manner, as seed is conveyed pneumatically into the open top end of the delivery passage 14, the seed is delivered into the seed chamber 46 of the bottom end of the opener where the flow of seeds is split into two laterally spaced apart rows at opposing sides of the splitter plate 54. The two rows of seed are effectively dispensed within respective portions of the referral formed by the two wings respectively.

The opener is typically manufactured by forming the main body, the knife portion and the wing body as an integral structure by welding. The leading edge members are provided along the front edge of each wing and are attached by welding, followed by placement of the nose member across both the flat front end of the wing body and the front ends of the leading edge members of the wings. In this manner the nose member spans a considerable lateral width across the front end of the opener and can be provided with a constant radius of curvature across the width thereof for optimal resistance against wear and breakage.

Various modifications can be made in my invention as herein above described, and many apparently widely different embodiments of same made. It is intended that all matter contained in the accompanying specification shall be interpreted as illustrative only and not in a limiting sense.

1. A furrow opener for mounting on a tool shank of an agricultural seeding implement to form a furrow in ground as the implement is displaced across the ground in a forward working direction, the furrow opener comprising:
a main body;
a mounting arrangement at a rear side of the main body to mount on the tool shank of the implement;
an upright knife extending along a front side of the main body; and
a pair of wings protruding laterally outwardly from opposing sides of the main body, the wings including respective leading edges along a front thereof which extend forwardly at a laterally inward slope towards a common apex;
the common apex between the leading edges of the wings being spaced forwardly from a bottom end of the upright knife; and
the common apex forming a radius of curvature between the leading edges of the wings.

2. The opener according to claim 1 wherein the radius of curvature is at least ¼ of an inch.

3. The opener according to claim 1 wherein the wings further comprise a wing body and a nose member supported on a front end of the wing body which defines the common apex, the nose member being formed of a wear resistant material which is harder than a material of the opener body and a material of the wing body.

4. The opener according to claim 3 wherein the wing body includes a front end face which spans laterally between the leading edges of the wings so as to be oriented perpendicularly to the forward working direction, the nose member having a rear end face opposite the common apex which is in abutment against the front end face of the wing body.

5. The opener according to claim 2 wherein the wings further comprise a pair of leading edge members supported on the wing body which define the leading edges of the wings, the leading edge members being formed of a wear resistant material which is harder than a material of the opener body and a material of the wing body.

6. The opener according to claim 5 wherein the nose member extends laterally outwardly in opposing directions in overlapping configuration across front ends of the pair of leading edge members respectively.

7. The opener according to claim 6 wherein the wing body includes a front end face which spans laterally between the leading edges of the wings so as to be oriented perpendicularly to the forward working direction, the front ends of the pair of leading edge members lying in a common plane with the front end face of the wing body.

8. The opener according to claim 2 wherein the nose member includes a front edge defining the radius of curvature of the common apex and an upper surface which is sloped upwardly and rearwardly from the front edge.

9. The opener according to claim 2 further comprising a leading edge member extending along a leading edge of the knife, the leading edge member on the knife terminating at a bottom end of the knife at a location which is spaced upwardly and rearwardly from the nose member that defines the common apex.

10. A method of forming a furrow opener for mounting on a tool shank of an agricultural seeding implement to form a furrow in ground as the implement is displaced across the ground in a forward working direction, the method comprising:
providing a main body having (i) a mounting arrangement at a rear side of the main body to mount on the tool shank of the implement, (ii) an upright knife extending along a front side of the main body, (iii) a wing body including a pair of wings protruding laterally outwardly from opposing sides of the main body, in which the wings include respective leading edges along a front thereof which extend forwardly at a laterally inward slope towards a common junction on the wing body, and in which the common junction between the leading edges of the wings is spaced forwardly from a bottom end of the upright knife; and
mounting a nose member on the common junction between the leading edges of the wings such that the nose member is spaced forwardly from a bottom end of the upright knife, in which the nose member forms a radius of curvature between the leading edges of the wings.

11. The method according to claim 10 wherein the radius of curvature is at least ¼ of an inch.

12. The opener according to claim 10 wherein the nose member is formed of a wear resistant material which is harder than a material of the opener body and a material of the wing body.

13. The method according to claim 10 further comprising providing a front end face on the wing body at said common junction which is oriented perpendicularly to the forward working direction and abutting a rear end face of the nose member against the front end face of the wing body.

14. The method according to claim 10 including providing a pair of leading edge members supported on the wing body which define the leading edges of the wings, the leading edge members being formed of a wear resistant material which is harder than a material of the opener body and a material of the wing body.

15. The method according to claim 14 further including supporting the nose member on the wings such that the nose member extends laterally outwardly in opposing directions in overlapping configuration across front ends of the pair of leading edge members respectively.

16. The method according to claim 15 wherein the front ends of the pair of leading edge members lie in a common plane with a front end face of the wing body against which the nose member is abutted.

17. The method according to claim 10 wherein the nose member includes a front edge defining the radius of curvature of the common apex and an upper surface which is sloped upwardly and rearwardly from the front edge.

18. The method according to claim 10 wherein the opener further comprises a leading edge member extending along a leading edge of the knife, the method including supporting the nose member at a location which is spaced downwardly and forwardly from a bottom end of the ledge edge member on the knife.
